(19) United States
(12) Patent Application Publication
(10) Pub. No.: US 2015/0073918 A1
(43) Pub. Date: Mar. 12, 2015

(54) System and Method for Handling and Distributing Identification Indicia and Contact Information

(71) Applicants: Terry Aronson, Hallandale Beach, FL (US); Johannes Breytenbach, Upper Coomera (AU)

(72) Inventors: Terry Aronson, Hallandale Beach, FL (US); Johannes Breytenbach, Upper Coomera (AU)

(21) Appl. No.: 14/483,314

(22) Filed: Sep. 11, 2014

Related U.S. Application Data
(60) Provisional application No. 61/877,262, filed on Sep. 12, 2013.

(51) Int. Cl. G06Q 30/02; H04L 29/06; H04L 29/08

(52) U.S. Cl. CPC G06Q 30/0269; H04L 67/10; H04L 63/083
USPC 705/14.66

(57) ABSTRACT

A system and method for handling and distributing identification indicia and contact information comprising the steps of: providing a program on a non-transitory computer readable medium; selectively providing access to said program to a customer; collecting input by the customer, said input received and compiled by the program; storing said input, said storing being on at least one database operatively associated with said program; and selectively providing output of said input, wherein said consumer selects the destination, output, and content of said output.

### INDEX TO RELATED APPLICATIONS

This application is a non-provisional of and claims benefit to U.S. Provisional Patent Application Ser. No. 61/877,262 filed Sep. 12, 2013 the disclosure of which is incorporated herein by reference in its entirety.

### BACKGROUND OF THE INVENTION

Information handling and distribution is a significantly important task in business. With all of the online and electronic tools available, there are still areas regarding information handling that do not meet the needs of most businesses. The present invention addresses these needs.

### SUMMARY OF THE INVENTION

### Brief Description of the Several Views of the Drawings

FIG. 1 is a flow chart of the system of the present invention.

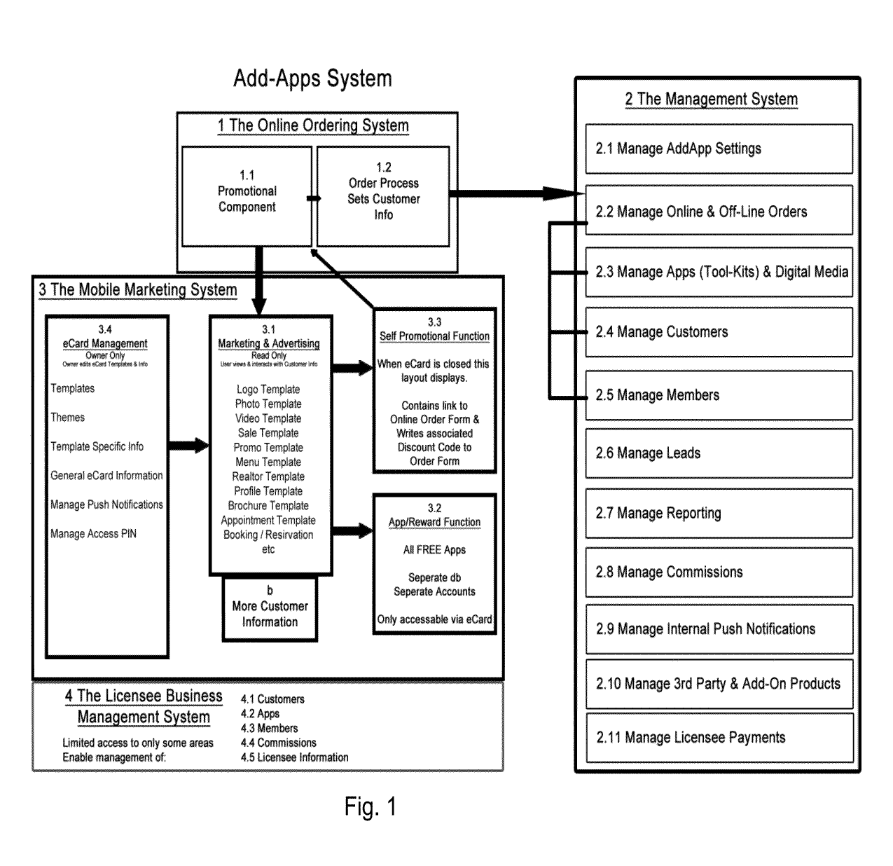

FIG. 2 is a flow chart of the ordering system of one embodiment of the present invention

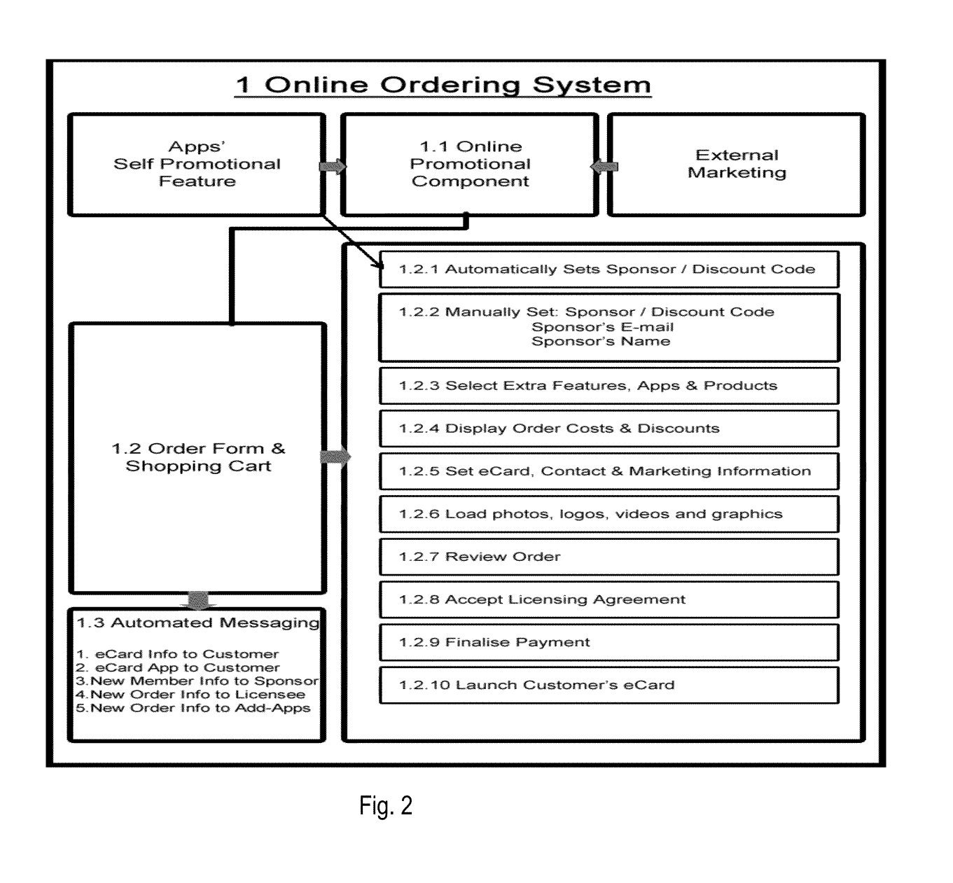

FIG. 3 is a flow chart of the self-promotional component of one embodiment of the present invention.

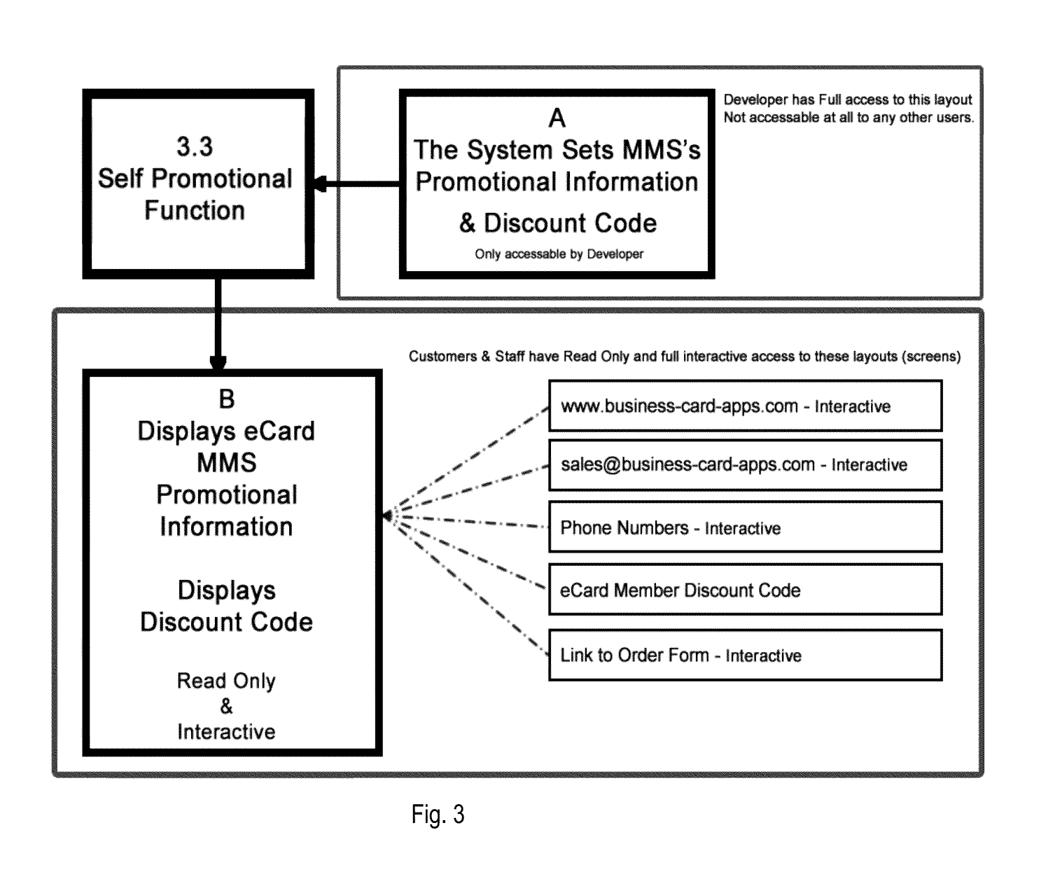

### DETAILED DESCRIPTION OF THE PREFERRED EMBODIMENT

The present invention is a combination of an eCard, a Mobile Marketing System, and a Customer Rewards tool. It advertises and promotes the eCard owner and their Business or Service while rewarding the recipient (customer/client or contact) for looking at it by giving them access to FREE valuable Business and Social Apps within the eCard. It is contemplated that the present invention be customizable and configurable including all components disclosed and described herein as well as sub combinations of select components as desired.

Alternatively eCard can be viewed as a Customer or Contact reward system that gives recipients FREE access to valuable business and social apps and digital products and in doing so also benefits the eCard owner through increased marketing, advertising and brand exposure.

The overall system is, however, much more than a single combination product. It is a “Mobile Marketing Business System”, enabling the marketing, sales, management and creation of a powerful product. The overall system has been designed and developed to enable duplication, thus creating totally separate “businesses” that can be independently managed under license via the eCard Management System.

The business Back Office Database functions are centrally managed by the add-apps System Administrator (Add-Apps, Data Discovery, Inc.) enabling each individual licensed business to focus on sales and marketing and income-generating activities.

The initial “back-office and database functions” were located on local servers; however, access speed, security, reliability and redundancy is better addressed in the “Cloud”. Field tests were conducted and before the Functionality and System was introduced to the market-place all Databases and Systems were installed on “Cloud” based computers with firewalls and redundancy.

eCard's System of the present invention has four main parts:

1. The Online Ordering System

2. The Management System

3. The Mobile Marketing System

4. The Licensee Business Management System

### The Income Generating Characteristic of the System

The present invention includes an Income Generating Mechanism. The invention has built-in functions to cater for different income generating mechanisms. The present invention systems have built in commission and reporting functions that enable management of different sales and commission structures.

In relation to sales, every person that receives an eCard can also order their own eCard MOBILE-MARKETING SYSTEM directly from the eCard, via numerous “ORDER NOW” buttons.

The present invention relates to direct sales in that it is purchased via an annual subscription fee and although the eCard system can be promoted in direct ways by company employees, online sales, direct sales and the normal range of marketing and advertising media, it is not the main sales methodology. One key element of the system sales power is via its in-built sales, “Self-Promotional Function”.

Additionally, the invention utilizes affiliate sales. When ordering an eCard of the present invention, users have the option to become “Platinum Members” (“affiliate sales members”). A “Platinum Member” receives a personal “system generated Discount Code”. This discount code is automatically associated with their eCard MOBILE-MARKETING SYSTEM. Platinum members can then receive a commission on each sale. Such sales are tracked by means of the “Discount Code” in the Management System.
Manual Discount Code entry. The Online Order form enables a prospective customer to enter a Platinum Members' Discount Code manually. By entering a valid discount code, a new eCard MOBILE-MARKETING SYSTEM purchaser receives an immediate discount for their purchase. Thus a Platinum Member can “advertise” (or promote) their eCard and customers who use the “discount code” will receive an immediate discount on their purchase. Such sales then also generate commission to the specific Platinum Members who is linked to that “discount code”.
Automatic Discount Code entry. Every eCard MOBILE-MARKETING SYSTEM forwarded by a Platinum Member contains their “Discount Code”. When a recipient sees the eCard MOBILE-MARKETING SYSTEM's Self-Promotional Page or “taps” any “ORDER NOW” link within the Platinum Member's eCard, the eCard's original Platinum Member's Discount Code is automatically recorded in the Online Ordering System and the sale commission is allocated to that Platinum Member.
Viral Effect—Repeated Automatic Discount Code entry. This “automatic discount code” is recorded no matter how many times an eCard is shared from one person to the next. This creates a viral sales effect for the Platinum Member. However, the moment someone orders their own eCard MOBILE-MARKETING SYSTEM and is given a “Platinum Member Discount Code”, their Discount Code will now be associated with their eCard MOBILE-MARKETING SYSTEM from that point forward and the originating Platinum Member's commissions cease.

In one embodiment, the present invention is further contemplated as utilized in a private label market. The eCard MOBILE-MARKETING SYSTEM also enables a “Private Label” setup. This means that a “license” can be granted to a corporation (or entity). A “Private Label” license holder has the right to on-sell the “private label” eCard MOBILE-MARKETING SYSTEM under their own “brand name”. They do so at a price that is regulated by the terms and conditions of their “license”. The Private Label licensee can therefore market the “private label” eCard MOBILE-MARKETING SYSTEM in exactly the same methods explained above. The Private Label can now recruit their own Sales Force and manage all sales through the Management System.

The eCard MOBILE-MARKETING SYSTEM keeps track of all sales and can therefore calculate the commission on sales made by Private Label licensees via “direct” sales, “viral” sales, etc.

A Private Label “licensee” can sell the eCard MOBILE-MARKETING SYSTEM in the same manner as explained above, they can also sell “Private Label agreements”, if permitted under their “licensing Agreement”.

The Private Label licensee can set up any Affiliate rewards program permitted under their license agreement. The eCard MOBILE-MARKETING SYSTEM can tract all sales and this information can be made accessible to the license holder via a specific “Private Label interface” (if permitted under their License). The system therefore also provides the functionality for Private Label licensees to manage their commission calculations and distribution.

Because of the flexibility of the Private Label licensing and the built in management systems, eCard MOBILE-MARKETING SYSTEM provides the ideal mechanism for a licensee to create and run a Multi-Level or Direct Sales Marketing sales structure. Once again the “viral” self-promotional characteristic of the system is a very powerful feature for such a distribution system as well as other types of “income generating” businesses.

The eCard MOBILE-MARKETING SYSTEM has built in commission “calculation and reporting functions” allowing management of all aspects of all sales.

The Licensee Management area enables email and SMS notification to all existing eCard owners. This enables direct communication and up-marketing of new Apps and or Digital Media to eCard owners.

In one embodiment, the invention includes an Online Ordering System having two main components:

The Promotional Component. This contains all the online marketing material and videos explaining the MOBILE-MARKETING SYSTEM.

The Order Form and Shopping Cart. The Order form is hosted separately. This enables easy duplication for Private Label businesses and other 3^{rd} party website. The order Form is always managed and hosted by Add-Apps, Data Discovery, Inc.
The Order Form automatically obtains the Sponsor/Discount Code from any eCard when accessed via an eCard Self-Promotional function. This enables all viral sales to be allocated to the appropriate “Sponsor”, Sales Consultant or Platinum Member.
The Order Form enables manual entering of the relevant Sponsor, Sales Person's Sponsor/Discount Code, their e-mail and name. This enables all orders that are not generated by the Self Promotional Function of other eCards to be traced back to the relevant Sponsor or Sales Person.
The Order Form provides the ability for customers to add the extra features, apps and products they want in order to enhance their MOBILE-MARKETING SYSTEM's appeal.
The Form displays the Order Cost and details for review.
The Order Form then requests the customer to enter all the eCard default template information required for a “complete” product. However, only the customer's Full Name and e-mail are compulsory as all other information can be added and managed via the eCard owner's Management Area.
The customer can also install their business logo and photo via the form.
On the Order Review page the customer can review their order and “edit” any aspect.
At this point the customer must accept the MOBILE-MARKETING SYSTEM's Licensing Agreement before they can proceed.
On acceptance of the Licensing Agreement the customer is directed to the checkout for payment authorization.
On completion of payment the Management System automatically generates the relevant eCard and provides the customer with their new eCard.

On successful payment the Online Ordering System is customizable and configurable to selectively output information. One output is by sends automated e-mail messages.
Customer's eCard Information. The system sends an e-mail to the new customer containing the following information:
   A welcome message.
   The Customer's System generated Management PIN.
   The Customer's System generated Sponsor/Discount Code if relevant.
   The Customers System generated eCard URL.
   The Customer's System generated eCard Download Page URL.
   The Video Help library URL.
The System email to customer. The email contains the eCard App with instructions on how to install the App (and, if necessary, FileMaker Go).
New Member Info to Sponsor. The system also notifies the relevant Sponsor/related Sales Person or Platinum Member that they have another successful sale. This email includes limited information regarding the new customer.
Notify the Licensee. A notification is also automatically sent to the Licensee, providing them with the new customer order information. This includes their email, the order total, the date of the order and who their Sponsor or relevant sales person is.
Notify Administrator—Add-Apps Data Discovery, Inc. Finally the system also notifies Add-Apps Data Discovery, Inc. about the new customer. This message contains most of the crucial order information, including which business made the sale, along with all the relevant order details.

At this point all the Order details have been automatically posted to the Management System.

### The Management System

The Management System of the present invention is only accessible by the Administrator (Add-Apps, Data Discovery, Inc.), developers, and authorized staff. The System does much more than simply manages the order. It is the heart of the Mobile Marketing System that enables management of all aspects of the system. This is the system through which the Administrator (Add-Apps, Data Discovery, Inc.) manages a specific Licensee or Business. It enables management of the following:
1. The Licensee or Business information and settings.
2. All aspects of Online and Of-line orders and Account creation
3. The Apps and digital media
4. All Customer aspects
5. Members
6. Leads
7. Reporting
8. Commissions payable to Licensee's
9. Internal marketing to Licensees via notifications
10. 3^{rd} party and other add on products.
11. Manage Licensee Payments

When the Administrator (Add-Apps, Data Discovery, Inc.) creates a new database “business entity”, it assigns the new Licensee's identity here. This is the area where all global settings for the system is stored and managed. All eCard MOBILE-MARKETING SYSTEM related communications obtain their mail merge information from here and all Order and commission calculations are based on these global settings. The following Licensee information is recorded and set here:

### Account Details

Here the following Licensee information is recorded and set.
Business and Contact information.
Delivery and Postal Address details.
P Server IP Address—This is key to generating eCard URL's and other automated settings.
Specific Licensee's Order Form URL.
Help URL.
General business information, logos and videos.

Here Add-Apps, Data Discovery, Inc. Administrator sets the various agreed costs for the different aspects of the MOBILE-MARKETING SYSTEM. These include but are not limited to:
The different Plan Costs.
The cost of all Optional Extras.
The cost of all 3^{rd} Party Products and features.
The agreed discount amounts for Platinum members if relevant.
The number of FREE Apps (Tool-kits) included in the different Plans etc.

### Manage Online and Off-Line Order

Order Entry System. All the Order details are posted to the Management System (2. Management System) (a “cloud based” online database) via the Online Ordering System (1. Online Ordering System) or directly via the Management System (2. Management System) by an Administrator of Add-Apps Data Discovery, Inc.
Identifies the required eCard MOBILE-MARKETING SYSTEM.
Provides the majority of details for the App (3.1.a eCard Marketing Function and 3.1.b. eCard More Customer Information).
Identifies all optional and provide relevant media.
If relevant, identifies the related Member or referrer.

An auto response is sent to the Customer with detailed information on what the next steps are and what they can expect.

An auto response is sent to Add-Apps, Data Discovery, Inc. containing all the Order details and flagging the new “Order”.

Order Management. This is where the system records all the Order Options and Information. It also serves as an Order Record management and not only stores the order information but also the actual order product components.

The System records the following customer information via the Online Order Form. This can also be done manually in the system:
The selected Plan.
Whether the video option has been chosen or not.
Whether the eCard Management option has been chosen or not.
Title.
Business Name.
Position.
Qualification.
First and Last Names (compulsory information).
Phone number, Direct Line, Mobile.
The Main e-mail (compulsory information).
Two additional e-mails and 3 different web addresses.
Delivery and Postal Address.
The Order Total.
The selected Apps (Tool-Kits) and link them as related records to this specific account.
The main logo, photo and video.
The main “YouTube” video Link. The system automatically changes the YouTube display link into an embed link for the iframe-code-field. It also automatically changes the iframe embed script into the display link for the link field if only the embed code is enters. This way the YouTube video that displays in the eCard video template is always embedded and is not only a link to YouTube.
The date and time of the order.
Whether the customer wants to display their location in a map or not.

Based on the record ID the system automatically creates an Account Name and Password.

Order distribution also takes place through this area. The correct order is simply emailed to the relevant Customer from here. The system automatically flags the order as Completed and captures the date and time the order was sent.

Account Management. This area captures and automatically generates all the account related information and data.

The Account Management tab contains the following functions:
It captures the Platinum Member Discount Code and Sales Person or relevant Sponsor's Code. This is done in one of the following ways:
   If the sale was initiated from the Self Promotional Area of an eCard, the system automatically captures that eCard's Platinum Member's Discount Code or relevant Sponsor's Sponsor Code. Now that code is passed from eCard to eCard till the selected order options triggers the generation of a new Platinum Member or Sponsor Code. The new code is then carrier forward.
   All sales that originate from a Licensee's website and not an existing eCard, requires that the customer enters the relevant Discount or Sponsor's Code manually in the order form. This is then captured by the system and attributed to the new eCard account.
The system automatically generates an Account Name and Password. It also automatically generates the Creation of a new Database Account with all the relevant information and assigns the pre-defined Privilege Set to the account. This Privilege set is what allows or disallow, enables or disables views, functions, scripts and layout access by the various types of users.
The system also automatically generates the eCard Management PIN (Interface Password) that enables the eCard Owner to manage their eCard information, Templates and themes.
The automatically generates the required URL and variable values that enables the owner and any other user to access the eCard via any browser.
The system then use the generated Account Name, Password and entered logo (default of the Licensee logo if no logo was selected) to generate a .mobileconfig file with the required values that enables access to the specific eCard via FileMaker Go on all iOS devices. It also stores this .mobileconfig file in the related container field of the database for later use and distribution.
The system records the date of payment and also sets the date the next payment is required and the number of days left before payment. Based on this the eCard owner's Payment Status is calculated and warning messages sent when an eCard is about to expire.
Based on the Order selections the system indicates whether the account is that of a normal eCard Owner or that of a Platinum Member/Sponsor/Sales Agent, and automatically generates the required account status and Discount/Sponsor Codes where relevant.

Order Distribution. All order distribution takes place automatically on successful payment processing by the relevant payment gateway. The gateway confirms successful payment via a specified script that triggers the necessary steps for all the above and distribution of the order.

On confirmation of payment the system send the following automated messages:
Customer's eCard Information. The system sends an e-mail to the new customer containing the following information:
   A welcome message
   The Customer's System generated Management PIN
   The Customer's System generated Sponsor/Discount Code if relevant
   The Customers System generated eCard URL
   The Customer's System generated eCard Download Page URL
   The Video Help library URL
The System emails the App (both android or Apple—FileMaker eCard App) to the Customer with instructions on how to install the app (and FileMaker Go for Apple devices).
New Member Info to Sponsor. The system also notifies the relevant Sponsor/related Sales person that they have another successful sale. This email includes limited information regarding the new customer.
A notification is also automatically sent to the Licensee, providing them with the new customer's order information. This includes their email, the order total, the date of the order and who their Sponsor or relevant sales person is.
Finally the system also notifies the Administrator Add-Apps, Data Discovery, Inc. about the new customer. This message contains most of the crucial order information, including which business made the sale, along with all the relevant order details.

Account Commission Management—The last part of the Order Function manages the Commission related to the specific order. It identifies and links the relevant Member to the order via the identified Discount Code or Sponsor Code and automatically calculates their applicable commission, depending on their type of membership and the Order Optional. It also identifies the Members' Sponsor and their relevant Sponsor Fee (if so configured).

### Manage Apps & Products

Every Product Master Copy is stored and its details recorded here. This includes a high level bug management function and any suggested functionality improvements for later versions. The various account records for managing the different components of the eCard MOBILE-MARKETING SYSTEM is also stored here. Access to the Product area is limited to developers.

Apps (Tool Kits) and products are not added by simply creating a new record in this area. This is simply an area that keeps all App (Tool-Kit) related data and records required for the Online Order Form and order and eCard account creation. The name, price, date, description and any additional development comments are stored here. From here the Administrator, Add-Apps, Data Discovery, Inc. also manages whether a specific App is ready for inclusion in the Order Form or not.

Any 3^{rd} Party product order information and cost are also stored here.

### Manage Customer

All MOBILE-MARKETING SYSTEM related customer management issues are handled via the Management System's Order Management area 2.2. Whether a customer needs to know their eCard Management PIN or their Discount or Sponsor Code, it can all be access here.

This enables the management of all customers and their related orders. The Information area stores the Customer's information and general media. This enables quick customer communication via interactive fields and areas. It also enables mail-merged emails and printing. The Information area stores the Customer's information and general media.

### Manage Members

The Member area enables the management of new Sponsor and new Platinum Member registrations. It links a member to its Discount Code and enables their referrals to be traced even via of-line efforts.

Member Information. This area also enables Member management “From-registration-to-communication”. It also records the Member's Sponsor and link them for Sponsor focused reporting.

### Manage Leads

This enables the capturing of all Landing Page and other online leads. It also allows for off-line generated lead registration. This in turn will drive multiple marketing campaigns including Email and SMS marketing.

### Manage Reporting

This area includes three main Reporting functions:

Sales Reports. The sales reports are Order value based and can be grouped by:
Customer.
Member.
Order Date.
Order Status.
Order Total.
Product.

Commission Reports. The sales reports are Order value based and can be grouped by:
Customer,
Commission Status,
Fee Status,
Member,
Order Date,
Order Status,
Order Total,
Product,
Sponsor

App user reporting. Data Discovery can see how many users in total are using each App (Tool-Kit) and which eCard they are related to.

### Manage Commissions

The Commission area lists all the Members/Sponsors' Orders and their relevant commission values. The orders are directly accessible from this area.

This area displays the following for each order:
The Customer ID
The Customer's Business Name
Their selected Plan
The number of Apps they added to the eCard
Their e-mail
Who is their Sponsor or Platinum Member
The Order Date
The Order Total
The Licensees licensing cost of the selected Plan, extra features, App and products.
The payment clearing house fees
The Total Cost for the Order
The commission payable to the Sponsor or Platinum member
The commission payment status and date of payment.

This area enables the grouping of commission for reporting and exporting purposes. The commission list can be sorted by:
Main Sorting Group—Sponsor or Platinum Member with Sub Group of Paid and Outstanding.
Main Sorting Group—Status e.g. Paid & Outstanding commissions—Sub Group Sponsor or Platinum Member.
Main Sorting Group—Month, Group all monthly orders—Sub Group, Sponsor or Platinum Member.
Main Sorting Group Week—Group all weekly orders by the week of the year e.g. week 31—Sub Group, Sponsor or Platinum Member.
Main Sorting Group—Account number.

These categories can also be displayed for any selected period, Member or Sponsor etc. All Sub Totals and Totals are automatically calculated and displayed. This data can be exported with the click of a button in multiple formats e.g. excel, .txt, .tab, .csv, .xml etc.

### Manage Internal & Other Marketing

Management of the database allows:
“Focused marketing” to all customers,
“Quantify consumer demand” for products/services and provide our client or their customers with solutions to their requirements.
Marketing to all existing eCard owners and Licensees.

### Manage 3^{rd} Party & Other Add on Products

It is possible to promote and link 3^{rd} party products to both the eCard and Apps (Tool-Kits). All marketing information, records and related product information can be managed from the Management System.

### Manage Licensee Payments

Add-Apps, Data Discovery, Inc. Administrator can also keep effective record of all commission payments to Licensees via the Management System.

Every new payment is recorded as a new record in the Payment List.

The detail of each payment can be viewed by selecting the relevant payment from the list.

When recording a payment from Add-Apps, Data Discovery, Inc. to the relevant Licensee, the following is recorder:
The Payment ID
The date the payment was made
The period the payment was made for
The order amount
The cost of transaction fees
The Final amount paid
It is also possible to store any digital receipt or proof of payment in the relevant record's container field.

### The Mobile Marketing System

At the heart of the Add-Apps, Data Discovery, Inc. System lies the eCard Mobile Marketing System.

The eCard MOBILE-MARKETING SYSTEM is valuable to a business (the owner of the eCard) because it:
Engages Customers with FREE Valuable & Functional software “tool-kit” Apps within the eCard.
Access Continually Promotes & Advertises the Business
Customers Access their FREE “tool-kit” Apps attached to eCard MOBILE-MARKETING SYSTEM, so each access by a customer displays the Business Owner's (the eCard owner) details, their contact information, marketing and their location.
Information on the eCard MOBILE-MARKETING SYSTEM is 100% Interactive, a customer can access the Business (eCard MOBILE-MARKETING SYSTEM owner):
   Tap to connect via phone
   Tap to email
   Tap to visit the eCard MOBILE-MARKETING SYSTEM website
   Tap to map business location
   Tap to SMS
   Tap to access their Social media information
   Tap to “blue-tooth”, etc.
eCard MOBILE-MARKETING SYSTEM owner can edit their eCard MOBILE-MARKETING SYSTEM home-screen information via numerous specialty “templates” and edit its color via numerous color “themes”.
eCard MOBILE-MARKETING SYSTEM owner can edit their eCard MOBILE-MARKETING SYSTEM “information screen” via their “eCard Management Area”, they can edit every item on the eCard MOBILE-MARKETING SYSTEM except their First and Last Name.
eCard MOBILE-MARKETING SYSTEM can be Distributed via:
   SMS
   Email
   iMessage
   Social media
   Web-site
   Viral marketing,
   Bluetooth, etc.

The eCard, Mobile Marketing System (MOBILE-MARKETING SYSTEM) is predominantly an eCard, a Mobile Marketing and a Customer Rewards tool. It is designed for mobile-devices (cell phone, tablet, etc.) and includes four main components and numerous sub-components.

Important eCard components are:
“Marketing and Advertising” components,
Apps within an App, (Apps within the eCard) the “Reward and Benefit” components,
“Self-promotional” components, and
“Management and edit” components
   eCard MOBILE-MARKETING SYSTEM Marketing & Advertising Component.

Reward—The eCard owner sends their eCard to all their contacts and customers. Through this eCard a business promotes and advertises themselves, their products, business or services, etc. In order to motivate their contacts and other recipients to look at their eCard as often as possible, the eCard provides an immediate benefit or “reward” to its recipient for doing so. This “reward and benefit” comes in the form of FREE business and/or social apps and/or digital media products.

Alternatively an eCard Owner can use their eCard as a reward in any loyalty or customer reward's program. This way a user earns a reward their customers and contacts with valuable Business and Social apps and systems and at the same time enjoy the benefit of “creating a captive audience group” for their MOBILE-MARKETING SYSTEM's marketing and advertising.

Marketing & Advertising Window—In one embodiment, a recipient can get an eCard from the Owner in different ways (See distribution). When a recipient opens an eCard the eCard Marketing & Advertising window displays (See 3.1.7 Registration). From here the recipient has various options, including accessing their FREE apps. However, no matter what a consumer wants to do next, they can only do so once they have viewed the eCard Owner's Marketing & Advertising window. Through the eCard Management Area (See eCard Management) the Owner sets the desired Marketing & Advertising template they want to display.

Marketing & Advertising Templates—Through different Templates the eCard Owner can select a variety of different Marketing Options, layouts and information fields. Some templates will also enable some limited functionality changes e.g. a Booking template will enable the Customer's contacts to book appointments straight from the Business Card component or the “menu” template allows a Restaurant to add their daily or weekly menu, etc. Other templates may display a photo of the customer on the main layout or a logo, etc. Some templates can allow for information changes e.g. phone numbers etc.

The Customer (eCard MOBILE-MARKETING SYSTEM owner) cannot change their name on the eCard MOBILE-MARKETING SYSTEM. No template allows for the change of the eCard MOBILE-MARKETING SYSTEM owner's name. The eCard MOBILE-MARKETING SYSTEM owner can therefore, not change the eCard MOBILE-MARKETING SYSTEM content to the point where they can pass it on to a third party as a separate or different eCard MOBILE-MARKETING SYSTEM.

The Customer manages these templates via the eCard Management area (See heading 3.4 eCard Management). These templates are immediately interchangeable (“cloud based” and editable) and are highly customizable (editable). The eCard Templates include, but are not limited to:
Business Card template
Personal Portfolio Template
Video advertisement template
Sales template
Promotional template
Menu template
Realtor template
Product Brochure template
Mobile Website template
Medical template
Social media template
Product List Template

These templates are designed to create maximum impact at first glance. As in all marketing and advertising media, first impressions are the lasting ones.

All templates are 100% interactive. From here users can contact eCard MOBILE-MARKETING SYSTEM owner via phone, SMS, Email or Bluetooth, etc. They can visit the eCard MOBILE-MARKETING SYSTEM owner's business websites, view their location, video or QR Codes—all at the tap of a finger.

The templates also have access to “Booking and Appointment” function. This enables users to make appointments and bookings with the eCard owner (or business) from the eCard. It also provides the eCard owner with an online booking and appointment management facility via their eCard Management area.

Interactive Templates—All the Templates are 100% interactive. This means that a user can phone, SMS or e-mail the eCard Owner straight from their e-Card. They can open the owner's website, see their shop or business location map, and scan their QR Code all from the eCard.

The More Information Window—All templates also have a link to the More Info window. This window is a generic window that displays additional information regarding the eCard Owner. This includes, but is not limited to:
a. Delivery address details
b. Postal address details
c. Additional contact details e.g. extra phone, mobile and fax numbers, Skype Name, Face Time link, extra e-mail and website addresses etc
d. Location map display
e. A short Bio of the eCard owner with extra photos etc
f. A Business portfolio of the eCard Owner's business.
g. Additional video and information.
h. A User Notification management link
i. A user social media share area.

Viral Component—The eCard can be shared by anyone with anyone. Because of the “Benefit Component” recipients often share a business owner's eCard with friends and family even though it is not their eCard. This SHARING creates a viral marketing effect for the eCard MOBILE-MARKETING SYSTEM owner, resulting in maximum marketing exposure at minimum cost.

Registration. When sharing an eCard MOBILE-MARKETING SYSTEM the recipient is asked to register the first time they open the eCard on a new device. Their email address is required to complete registration. They can also indicate witch industry they work in. Registration is preferred but not compulsory and will automatically add them to the eCard's Opt-In list. This way the eCard Owner can send promotional and marketing e-mails and SMS to his/her eCard recipients. Message creation and sending are done via the eCard Management area. The industry indication enables the eCard owner to send out “Group” specific notifications.

Opt-In Management—Any recipient can “opt-out” at any time via the eCard's “More Info” window. They access this area via an icon in the More Info area and enter the email address that they registered with. This opens their Opt-In management area where they can opt in or out via radio buttons. Here they can also add or change their mobile number and the industry they are associated with.

Download eCard from the Web. The eCard MOBILE-MARKETING SYSTEM also generates a “download page” link that eCard MOBILE-MARKETING SYSTEM owners can post on their website. This way any visitors can “download” their eCard and have access to the FREE Apps and/or digital products linked to the eCard. This window includes links to the relevant download area in Google Play and the iTunes App Store. This is another mechanism through which the eCard owner can enlarge their mobile-marketing and advertising audience group.

Sharing of eCard MOBILE-MARKETING SYSTEM through Social Media. The eCard MOBILE-MARKETING SYSTEM can be shared via all social media environments, thus reaching online contacts that are otherwise not possible to reach.

Cost. When a business purchases an eCard MOBILE-MARKETING SYSTEM they pay an annual subscription fee, irrespective of how many eCards they distribute (via Email, SMS or by other means). Each eCard MOBILE-MARKETING SYSTEM comes with a set number of FREE Apps and/or digital media attached. Additional Apps and/or digital media products can be added at a future time.

eCard App within an App (Tool-Kit) Component

Apps within an App (Tool-Kit) Function—This component an eCard's owner's customer to keep engaged, each time they use the “App” they see details about the eCard owner's business.

The “App within and App” (known as “tool-kits”) function, has the following Functions:
Keeps a Business Customer Engaged, each time they use the “App” they see details about the referring business.
100% Customer Focused.
“Tool-Kits” are the heart of the eCard MOBILE-MARKETING SYSTEM ability to keep Customer/Client's ongoing interest.
eCard can be forwarded by:
   An eCard MOBILE-MARKETING SYSTEM owner to its contacts and customers
   On-forwarded by these contacts and customers for use by their contacts and customers—thus enhancing the “Viral” component of the eCard MOBILE-MARKETING SYSTEM Apps.
   Further on-forwarded by these contacts and customers, etc.

These App “Tool-Kits” are the heart of the eCard MOBILE-MARKETING SYSTEM ability to keep Customer/Client's ongoing interest.

This part can differ for each eCard MOBILE-MARKETING SYSTEM depending on the owner's requirements. This component is 100% focused on its designated purpose. This part of the eCard MOBILE-MARKETING SYSTEM represents the value aspect for the end user. Add-Apps, Data Discovery, Inc. designed multiple purpose-built and “industry specific” “tool-kit” Apps that meet end user needs. The following are some examples:
My Wallet—An app where users can store all their passwords and usernames etc safe and securely.
My Warranties—An app where users can keep all their warranty receipts and related information safe and securely.
My Invoices—A mobile invoicing system.
My Time Billing—A mobile time billing system.
My Journal—A digital media and text journaling app.
Surprise Me—A Wish list app for groups, wedding registers, families etc.
My Goals—A goal setting app for individuals, managers and coaches.
My Health & Fitness—Exercise app that can be managed by an individual or personal trainer.

In all cases users have Record Creation, Deletion and Edit access—only Add-Apps, Data Discovery, Inc. Administrator has Design access.

User Reward or Benefit—The purpose of these apps and digital media is to serve as a reward for the recipient. Marketing and Advertising material have no “direct immediate” benefits to their recipients. The apps and digital products that are attached to en eCard give it real, tangible and immediate value. It provides an immediate benefit to anyone that opens and looks at the eCard Owner's Marketing & Advertising. The purpose of this is to:
a. Entice or motivate the recipient to open the Owner's eCard more often as it benefits them.
b. Once a recipient starts using the attached apps, they become part of the eCard's “captive audience group” as many of the apps store valuable data and information of the recipients and they would be compelled to keep using those apps once they started.

Compulsory Viewing—Any app or digital product that a recipient wants to use or view can only be accessed via an eCard's Marketing & Advertising window. Any recipient that wants to use any app that is linked to an eCard will therefore first view the Owner's Marketing & Advertising window. They are compelled, even if for only a moment, to first be exposed to the eCard Owner's Marketing & Advertising.

Marketing Enhancements—The benefit of the eCard to its owner is its Marketing Component. A larger number of users brings more value to eCard MOBILE-MARKETING SYSTEM's owner. The eCard MOBILE-MARKETING SYSTEM owner can enhance the appeal of their eCard MOBILE-MARKETING SYSTEM by incorporating additional Apps and/or digital media into their eCard MOBILE-MARKETING SYSTEM. A wider range and variety of apps and/or digital media results in a larger percentage of users' needs or interests being met. Users become part of a captive audience group for the eCard MOBILE-MARKETING SYSTEM owner as soon as users (customers or contacts) start using any of the FREE Apps and/or digital media products.

eCard Owner can “add” additional Apps (tool-kits) to their eCard through the Online Ordering system. They simply identify themselves through their Member Number and Management PIN. Once their identification is confirmed the order form displays all the Apps that are already part of their MOBILE-MARKETING SYSTEM. They can then simply select any additional apps they want. On successful payment these Apps are automatically added to their eCard. An automated e-mail is also sent to all their registered contacts, informing them that they now have access to even more FREE Apps (Tool-Kits).

eCard MOBILE-MARKETING SYSTEM Upgrades. eCard MOBILE-MARKETING SYSTEM owners can add any number of additional Apps and/or digital products at any time to enhance their eCard MOBILE-MARKETING SYSTEM's appeal. When this is done all “opt in” eCard recipients are automatically notified that they now have access to more FREE Apps and/or digital media products. This capability also provides a powerful “up-selling” opportunity to the Add-Apps Licensees. Every time a new App or Digital Product is added, they can try and “up-sell” all existing eCard Owners.

The App within an App Management—All aspects of the incorporated apps are managed by Add-Apps, Data Discovery, Inc. via the Management System, see heading 2. Management System above. Some components of the apps can also be managed by the relevant Licensee via the Licensee Management Area. (See heading 4. Licensee Management Area).

### The Self Promotional Component

The Self-Promotional Function of eCard MOBILE-MARKETING SYSTEM. The eCard MOBILE-MARKETING SYSTEM contains points from which a user can order their own eCard MOBILE-MARKETING SYSTEM. Typically the eCard MOBILE-MARKETING SYSTEM system's “Close window” is a “Self-Promotional Window” that advertises eCard and its benefits.
3.3.1.a. Every time an eCard MOBILE-MARKETING SYSTEM user closes an eCard MOBILE-MARKETING SYSTEM they are invited to Order their own eCard MOBILE-MARKETING SYSTEM,
3.3.1.b. Because of the potential viral effect of the eCard MOBILE-MARKETING SYSTEM, eCard MOBILE-MARKETING SYSTEM also has the ability to generate “viral marketing” sales for the eCard MOBILE-MARKETING SYSTEM owner. From here the user can:
   Close the App,
   Phone MOBILE-MARKETING SYSTEM, Mobile Marketing System from this window—interactive number displays
   Email MOBILE-MARKETING SYSTEM, Mobile Marketing System from this window.
   Visit MOBILE-MARKETING SYSTEM, Mobile Marketing System website from this window.
   Go straight to the Add-Apps Order Form from this window.
   Obtain a Discount Code that when entered in the MOBILE-MARKETING SYSTEM, Mobile Marketing System shopping cart, gives them an instant savings on purchase. This Discount Code can be linked back to sales agents and referrals.
   See MOBILE-MARKETING SYSTEM, Mobile Marketing System various promotional material and “up-marketing” material.

Users can manage their own eCard through this function. They can manage:
Their eCard Management Access
All their eCard Information
Their eCard Templates and Template information and media
Their eCard'd Theme
All e-mail and sms notifications.

Secure Access. An eCard Owner can access their eCard management area via a secure area accessible with a system's generated Management PIN. Their Management PIN is automatically generated and e-mailed to them on completion of their initial order. They can change this PIN at any time in the eCard Management area.

Manage eCard Information—All the additional information that displays in the More Info area can also be added or edited in this area except the eCard Owner's First Name and Last Name. Their name always remains linked to a specific eCard. This includes, but is not limited to:
a. Delivery address details
b. Postal address details
c. Additional contact details e.g. extra phone, mobile and fax numbers, Skype Name, Face Time link, extra e-mail and website addresses etc
d. Location map display
e. A short Bio of the eCard owner with extra photos etc
f. A Business portfolio of the eCard Owner's business.
g. Additional video and information.

Current Templates include, but are not limited to:
Business Card template
Personal Portfolio Template
Video advertisement template
Sales template
Promotional template
Menu template
Realtor template
Product Brochure template
Mobile Website template
Medical template
Social media template
Product List Template

Themes. The eCard owner also can choose from more than 35 different Themes. These themes change eCard MOBILE-MARKETING SYSTEM's color, look and appearance.

Push Notification—Notification Management. The eCard MOBILE-MARKETING SYSTEM owner can also send out any push notifications, emails and or SMS to customers from here. The eCard owner can use a “quick” pre-set notification or go into the “Notification Management” function and manage advanced settings. This “Management Area” enables the eCard owner to:
Group customers,
Send targeted push notifications to all, or
Selected groups of customers.
   Accessing an eCard or Mobile Marketing System

Cloud Based—Initial Functionality had the eCard MOBILE-MARKETING SYSTEM resident on a smart mobile device; however, it became immediately apparent that full Functionality could not be achieved.

Further field testing using the “cloud” expanded the eCard MOBILE-MARKETING SYSTEM into:
An eBusiness Card
An eCard MOBILE-MARKETING SYSTEM
A Mobile marketing system
A Viral Marketing System
A Mobile Web Site
A “Social Media” access point

Accessibility. The eCard MOBILE-MARKETING SYSTEM runs on a central “Cloud” based database that can be accessed via multiple platforms and devices. Each eCard MOBILE-MARKETING SYSTEM is stored on a “cloud based” database that enables ready access to the eCard MOBILE-MARKETING SYSTEM via the “Cloud”.
Users can access the database from any mobile device (iOS, Android, Microsoft, Blackberry, etc.) via a very powerful mobile database client.
eCard MOBILE-MARKETING SYSTEM is also accessed via web apps. Users can access eCard MOBILE-MARKETING SYSTEM and all the attached Apps and digital media products via any device that has a web browser (the device does not need to be a mobile device).
eCard MOBILE-MARKETING SYSTEM system can also be accessed via Android and Apple apps. The eCard MOBILE-MARKETING SYSTEM can therefore be accessed and “edited” by all iOS, Android, Windows, Blackberry and most other mobile devices,
eCard MOBILE-MARKETING SYSTEM can also be accessed and “edited” on all PC and MAC desktop and laptop computers.

When a user opens any eCard MOBILE-MARKETING SYSTEM, after it's been registered (see Registration) the first window that displays is the eCard Marketing & Advertising Window. Here the user has several options. They can:

Interact with most of the fields in the eCard MOBILE-MARKETING SYSTEM, Main Display. That is they can:
Phone the eCard MOBILE-MARKETING SYSTEM owner from here
Email them from this window
Access their website from this window
View their video from this window
View their photo from here
View their promotions, sales, specials, etc. from this window

In the “More Customer Information area”—Here the user can:
See the eCard MOBILE-MARKETING SYSTEM owner's locations and locate them on Google maps (if selected by the owner)
View the eCard MOBILE-MARKETING SYSTEM owner's promotional videos
Access the eCard MOBILE-MARKETING SYSTEM owner's eCommerce Shop
Interact with the eCard MOBILE-MARKETING SYSTEM owner's communication interface (if selected by the owner)
Phone the eCard MOBILE-MARKETING SYSTEM owner from here
Email the eCard MOBILE-MARKETING SYSTEM owner from this window
SMS the eCard MOBILE-MARKETING SYSTEM owner from this window
Access the eCard MOBILE-MARKETING SYSTEM owner's social media sites from this window (if selected by the owner)
View the eCard owner's bio and additional information and videos.
View the Business portfolio and additional information and videos.

From here they can also access their “Opt In” settings via the relevant icon and entering their email. In the Opt In area they can select Yes or No to email and or SMS push notifications, edit their email and mobile numbers and edit or select an industry they work in.

Immediately move on to the App Menu and access the desired app.

Close the eCard MOBILE-MARKETING SYSTEM using the main Close icon. This will automatically navigate the user to 3.3 The Self-Promotional window of the eCard MOBILE-MARKETING SYSTEM. This Function provides marketing for Add-Apps as well as providing any “user” to “order” their own eCard MOBILE-MARKETING SYSTEM.

Press the Home button—eCard MOBILE-MARKETING SYSTEM will be minimized and the user's home screen displays.

Most frequently used options will be for the user to (1) enter the More Info area, and (2) enter the “Tool-Kit App” Functions.

### The Licensee Business Management System

The total system can easily be duplicated, thus creating separate, independent database and business environments. This creates the need for a separate Licensee Management Environment. Through the Licensee Business Management System, a Licensee can manage those issues and aspects relevant to their business and access level for the following:
Their Customers
Their Apps (Tool-Kits) and Other Products
Their Members and or Sponsors
Their Business
Their Commission

Customer Management—Limited access to Customers. If Customers (eCard Owners) have any questions related to their eCard or Account Information, the relevant Licensee needs to be able to access this information without having to request it from Add-Apps, Data Discovery, Inc. This can be done via the Customer window in the Licensee Menu.

Account Information—This is where the Licensee can view a specific Customer's (eCard Owner) Account information and settings.

This area enables the Licensee to:
View all the Customer's account details—Read Only Access
View who their Sponsor or Platinum Member is.—Read Only Access
View What their Sponsor Code or Discount Code is.—Read Only Access
View and set the Customer's Monthly Membership (if relevant)—Edit Access
View and reset the Customer's last payment date.—Edit Access
Re-distribute the eCard to the Customer manually.—Send Only Access
Open the Customer's web app from here.—View Only Access
Open the Customer's download page from here.—View Only Access

The Licensee has limited access to the following information regarding the Customer's order:
The Plan Details—Read Only Access
The Order Total—Read Only Access
Which Apps are linked to their eCard—Read Only Access
Their media information—Read Only Access

### Relevant Commission Information

This function enables the Licensee to review the Commission payable for each order. That is the commission payable to the Licensee from Add-Apps, Data Discovery, Inc. The system displays:
The Order Total.
The Cost of the Plan, Video, Website, Extra Tool-Kits or Apps and Payment Processing Fees.
The commission payable and the date it was paid.

Customer eCard MOBILE-MARKETING SYSTEM Information This is where the Licensee can view the Customer's contact detail. They can also e-mail or phone a contact straight from this area. All fields are view only.

App (Tool Kit) Management—Here a Licensee can manage all relevant aspects of the Apps (Tool-Kits) available to their MOBILE-MARKETING SYSTEM. They can see all the apps available to them via the App List view.

Here they can:
Set the app's Category—e.g personal, business, private etc.—Edit
Select if they want to make it available on their Online Order Form or not.—Edit ability
Set the price they want to charge for the App. When they edit it here it automatically updates in their Online Ordering System.
View the description of the app—View Only
View any comments on the app—View only.

Members or Sponsors—This area enables the Licensee to view all those Customers that are Platinum Members or Sponsors. That is, those Customers that has the authority to sell the MOBILE-MARKETING SYSTEM on behalf of the Licensee. The Licensee views the Members via the Member List View.

Here they can view all Member information, “View Only”.

### Licensee Information

Here the Licensee can manage the following aspects of their information and settings.
Licensee Information
Price Management & Costs
Licensing Agreement

### Licensee Information

Here the Licensee can manage the pricing of their set plans and optional extras. They can also manage any 3^{rd} party product costs here if relevant.

The licensee has Read-Only access to the various cost elements of the MOBILE-MARKETING SYSTEM. These include but are not limited to:
The Plan Cost
The Video and any optional Extra's Cost
Any additional App costs
3^{rd} Party and other product costs.

Licensing Agreement—Here the Licensee has Read-Only access to the licensing agreement that applies to the eCard MOBILE-MARKETING SYSTEM.

### Commission List

The Commission List display all commission earned by each Sponsor or Platinum member. It also groups in Outstanding and Paid commissions.

This area displays the following for each order of each Sponsor or Platinum Member:
The Customer ID
The Customer's Business Name
Their selected Plan
The number of Apps they added to the eCard
Their e-mail
Who their Sponsor or Platinum Member is.
The Order Date
The Order Total
The Licensees licensing cost of the selected Plan, extra features, App and products.
The payment clearing house fees
The Total Cost for the Order
The commission payable to the Sponsor or Platinum member
The commission payment status and date of payment.

This information can be exported in multiple formats e.g. excel, tab delineated, comma separated, XML etc.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for handling and distributing identification indicia and contact information comprising:
a program on a non-transitory computer readable medium;
selectively providing access to said program to a customer;
said program configured for collecting input by the customer, said input received and compiled by the program;
storing said input, said storing being on at least one database operatively associated with said program;
selectively providing output of said input, wherein said consumer selects the destination, output, and content of said output.

2. The system of claim 1 wherein said output is sent to the consumer for distribution outside of the system.

3. The system and method of claim 1 wherein said output is sent to the consumer for distribution outside of the system via at least one of e-mail, downloadable links, executable files, social media, or combinations thereof.

4. The system of claim 1 wherein said output is provided in a presentation format selected by the consumer.

5. The system of claim 1 wherein said output is provided in a presentation format selected and editable by the consumer.

5. The system of claim 1 wherein said access is password protected access and is accomplished through the Internet, telephone, or other means of electronic communication.

6. The system of claim 1 wherein said output is sent to the consumer for distribution outside of the system via at least one of e-mail, downloadable links, executable files, social media, or combinations thereof.

7. The system of claim 1 wherein said output is format selected by the consumer.

8. A method for handling and distributing identification indicia and contact information comprising the steps of:
providing a program according to claim 1 on a non-transitory computer readable medium;
selectively providing access to said program to a customer;
collecting input by the customer, said input received and compiled by the program;
storing said input, said storing being on at least one database operatively associated with said program;
selectively providing output of said input, wherein said consumer selects the destination, output, and content of said output.

9. The method of claim 8 wherein said output is sent to the consumer for distribution outside of the system.

10. The method of claim 8 wherein said output is sent to the consumer for distribution outside of the system via at least one of e-mail, downloadable links, executable files, social media, or combinations thereof.

11. The method of claim 8 wherein said output is provided in a presentation format selected by the consumer.

12. The method of claim 8 wherein said output is provided in a presentation format selected and editable by the consumer.

13. The method of claim 8 wherein said access is password protected access and is accomplished through the Internet, telephone, or other means of electronic communication.
